(19) United States
(12) Patent Application Publication
(10) Pub. No.: US 2024/0242333 A1
(43) Pub. Date: Jul. 18, 2024

(54) IMAGE PROCESSING APPARATUS AND IMAGE PROCESSING METHOD

(71) Applicant: CANON KABUSHIKI KAISHA, Tokyo (JP)

(72) Inventors: Tomohiro SATO, Tokyo (JP); Junichi KODAMA, Tokyo (JP); Yuki KAMAMORI, Kanagawa (JP)

(21) Appl. No.: 18/624,185

(22) Filed: Apr. 2, 2024

Related U.S. Application Data
(63) Continuation of application No. PCT/JP2022/039075, filed on Oct. 20, 2022.

(30) Foreign Application Priority Data
Oct. 22, 2021 (JP) 2021-173416
Sep. 2, 2022 (JP) 2022-140209

(51) Int. Cl. G06T 7/00; G06T 3/40

(52) U.S. Cl. CPC G06T 7/0008; G06T 3/40

(57) ABSTRACT

An image processing apparatus includes a folder management unit that performs generation and setting of a folder that manages images for detecting a defect of an inspection target, and an image management unit that sets the images managed in the folder. The folder management unit sets a resolution of the images managed in the folder, and the image management unit applies the resolution set by the folder management unit to the images managed in the folder.

### CROSS-REFERENCE TO RELATED APPLICATIONS

This application is a Continuation of International Patent Application No. PCT/JP2022/039075, filed Oct. 20, 2022, which claims the benefit of Japanese Patent Application Nos. 2021-173416, filed Oct. 22, 2021 and 2022-140209, filed Sep. 2, 2022 which are hereby incorporated by reference herein in their entirety.

### BACKGROUND OF THE INVENTION

### Field of the Invention

The present invention relates to an image processing technique for detecting a defect from an image obtained by capturing an inspection target.

### Background Art

There is provided a method of detecting a defect such as a crack by performing, by a computer apparatus, machine learning for an image obtained by capturing an inspection target such as a wall surface of a concrete structure, and detecting the attribute of the defect such as the width of the crack by image analysis.

PTL 1 describes a system in which a user terminal transmits, to a server apparatus, a plurality of images obtained by capturing an inspection target, and the server apparatus detects a defect by performing image analysis for a composite image obtained by compositing the plurality of images. In the system described in PTL 1, it is possible to correct an analysis result (crack), and add attribute information (the width of the crack) to the analysis result (crack), and these pieces of information are accumulated in a database in association with each other. It is also possible to superimpose and display, on the user terminal, the crack and a scale image representing the actual size.

### CITATION LIST

### Patent Literature

PTL 1: Japanese Patent Laid-Open No. 2020-38227

An image obtained by capturing a defect does not include actual size information of the defect, and it is necessary to correctly designate information such as an image resolution representing an actual size value per pixel of the image to perform accurate determination. However, the number of images captured on site is large and the capturing status is different depending on a capturing target. Therefore, it is necessary to manually input information such as an image resolution for each image.

### SUMMARY OF THE INVENTION

The present invention has been made in consideration of the above problem, and reduces the burden of an operation of setting information such as a resolution for a detection target image.

In order to solve the aforementioned problems, the present invention provides an image processing apparatus comprising: a folder management unit that performs generation and setting of a folder that manages images for detecting a defect of an inspection target; and an image management unit that sets the images managed in the folder, wherein the folder management unit sets a resolution of the images managed in the folder, and the image management unit applies the resolution set by the folder management unit to the images managed in the folder.

In order to solve the aforementioned problems, the present invention provides an image processing method comprising: generating and setting a folder that manages images for detecting a defect of an inspection target; and setting the images managed in the folder, wherein in the folder setting, a resolution of the images managed in the folder is set, and in the image setting, the resolution set in the folder setting is applied to the images managed in the folder.

Further features of the present invention will become apparent from the following description of exemplary embodiments with reference to the attached drawings.

### BRIEF DESCRIPTION OF THE DRAWINGS

FIG. 1 is a block diagram showing a hardware configuration of an image processing apparatus according to the first embodiment.

FIG. 2 is a functional block diagram of the image processing apparatus according to the first embodiment.

FIG. 3 is a view exemplifying an image list screen according to the first embodiment.

FIG. 4 is a view exemplifying a folder generation screen according to the first embodiment.

FIG. 5 is a view exemplifying an analysis result list screen according to the first embodiment.

FIG. 6 is a view exemplifying an analysis result browsing screen according to the first embodiment.

FIG. 7A is a view illustrating a method of calculating actual size information according to the first embodiment.

FIG. 7B is a view illustrating the method of calculating the actual size information according to the first embodiment.

FIG. 8 is a flowchart showing processing of executing image analysis according to the first embodiment.

FIG. 9 is a view exemplifying an image analysis method selection screen according to the third embodiment.

FIG. 10 is a view exemplifying a folder structure according to the fourth embodiment.

FIG. 11 is a view exemplifying a subfolder generation screen according to the fourth embodiment.

FIG. 12 is a view exemplifying a folder editing screen according to the fourth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

The first embodiment will describe an example in which when a computer apparatus operates as an image processing apparatus, and manages, in a folder, a plurality of images for detecting a defect from images obtained by capturing an inspection target, an image resolution set by the user is applied to the images managed in the folder to reduce the burden of setting a resolution for each image by the user.

Note that the defect is a crack or the like occurring on a concrete surface due to damage, deterioration, or another factor of a concrete structure such as a motorway, bridge, tunnel, or dam, and the crack is linear damage with a start point, an end point, a length, and a width, which occurs on a wall surface or the like of the structure due to deterioration over time, the shock of an earthquake, or the like.

### <Hardware Configuration>

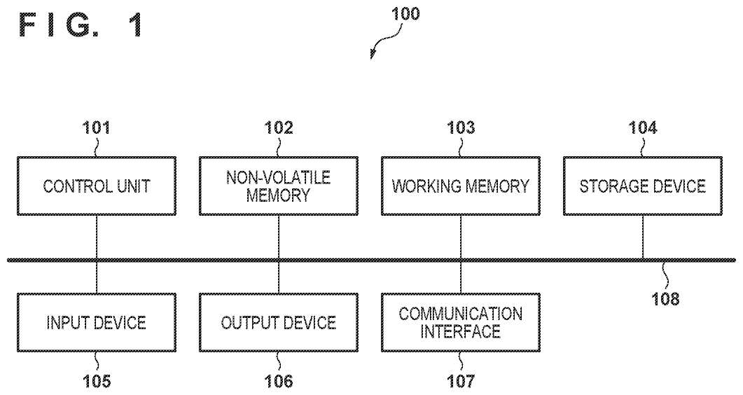

First, a hardware configuration of the image processing apparatus according to the first embodiment will be described with reference to FIG. 1.

FIG. 1 is a block diagram showing a hardware configuration of an image processing apparatus 100 according to the first embodiment.

In the first embodiment described below, a computer apparatus operates as the image processing apparatus 100. The processing of the image processing apparatus of the present embodiment may be realized by a single computer apparatus or may be realized by functions being distributed as necessary among a plurality of computer apparatuses. The plurality of computer apparatuses are connected to each other so as to be capable of communication.

The image processing apparatus 100 includes a control unit 101, a non-volatile memory 102, a working memory 103, a storage device 104, an input device 105, an output device 106, a network interface 107, and a system bus 108.

The control unit 101 includes a computational processor, such as a CPU or an MPU, for comprehensively controlling the entire image processing apparatus 100. The non-volatile memory 102 is a ROM for storing a program to be executed by the processor of the control unit 101 and parameters. Here, the program is a program for executing processing of first and second embodiments, which will be described later. The working memory 103 is a RAM for temporarily storing programs and data supplied from an external apparatus and the like. The storage device 104 is an internal device, such as a hard disk or a memory card incorporated in the image processing apparatus 100; an external device, such as a hard disk or a memory card connected to the image processing apparatus 100 so as to be capable of being attached thereto and detached therefrom; or a server device connected via a network. The storage device 104 includes a memory card, a hard disk, and the like configured by semiconductor memory, a magnetic disk, and the like. The storage device 104 also includes a storage medium configured by a disk drive for reading data from and writing data to an optical disk, such as a DVD or a Blu-ray Disc.

The input device 105 is an operation member such as a mouse, a keyboard, or a touch panel for receiving a user operation, and outputs operation instructions to the control unit 101. The output device 106 is a display device, such as a display or a monitor configured by an LCD or organic EL, and displays data held by the image processing unit 100 or data supplied from an external device. The network interface 107 is connected to a network, such as the Internet or a local area network (LAN), so as to be capable of communication. The system bus 108 includes an address bus, a data bus, and a control bus for connecting each of the components 101 to 107 of the image processing apparatus 100 so as to exchange data.

The non-volatile memory 102, stores an operating system (OS), which is basic software to be executed by the control unit 101, and applications for realizing applied functions in cooperation with the OS. Further, in the present embodiment, the non-volatile memory 102 stores an application with which the image processing apparatus 100 realizes image analysis processing to detect defects in images captured of an inspection target, which will be described later.

The processing of the image processing apparatus 100 according to the present embodiment is realized by reading the software provided by the application. It is assumed that the application includes software for utilizing basic functions of the OS installed in the image processing apparatus 100. The OS of the image processing apparatus 100 may include software for realizing the processing according to the present embodiment.

### <Functional Configuration>

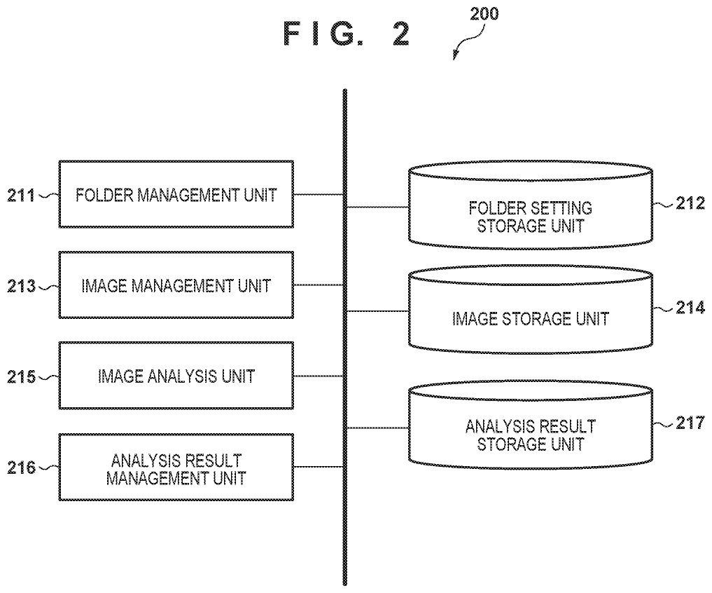

Next, functional blocks of the image processing apparatus according to the first embodiment will be described with reference to FIG. 2.

FIG. 2 is a functional block diagram of the image processing apparatus 200 according to the first embodiment.

An image processing apparatus 200 includes a folder management unit 211, a folder setting storage unit 212, an image management unit 213, an image storage unit 214, an image analysis unit 215, an analysis result management unit 216, and an analysis result storage unit 217. Each function of the image processing apparatus 200 is formed by hardware and software. Note that each function unit may be formed as a system that includes one or a plurality of computer apparatuses and a server apparatus which are connected by a network.

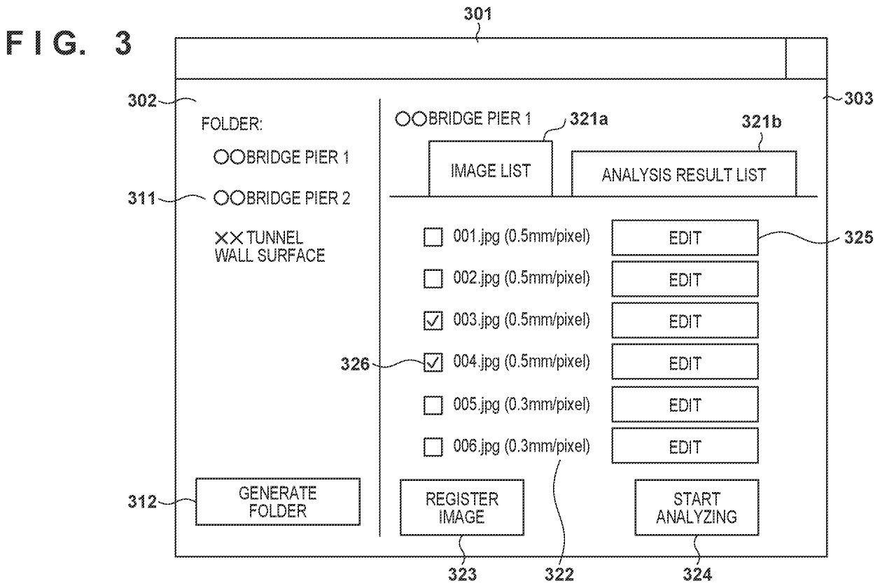

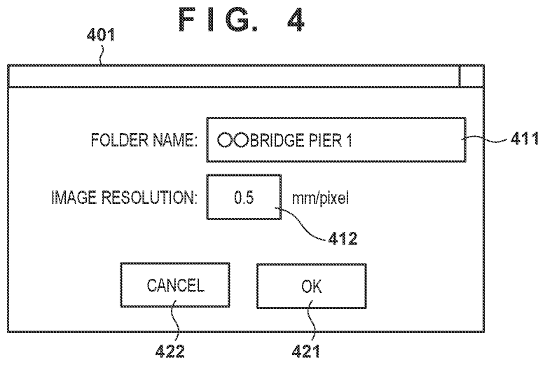

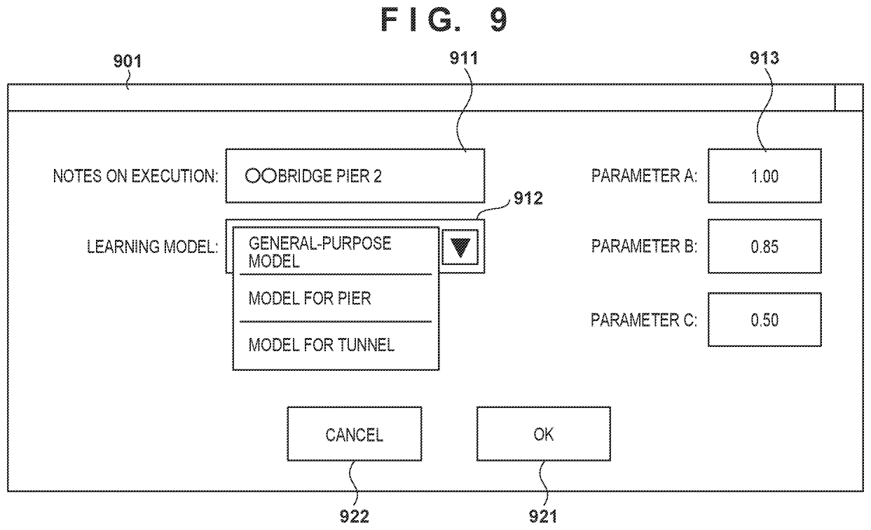

The folder management unit 211 has a function of performing at least one of generation, setting, deletion, and list display of folders. The folder setting storage unit 212 has a function of storing folder settings. The folder management unit 211 presents, to the user, an image list screen to be described later with reference to FIG. 3, a folder generation screen to be described later with reference to FIG. 4, and an image analysis method selection screen to be described later with reference to FIG. 9. When generating a folder, the user inputs folder settings such as a folder name and an image resolution to the folder generation screen. The folder settings include a folder name and an image resolution, and may also include information such as notes on execution input when generating a folder, and the generation date and time and the access date and time for folder management. The image resolution is actual size information per pixel of an image, and is, more specifically, a conversion value representing an actual size value (for example, mm) per pixel of an image, and an image/actual size ratio (mm/pixel) representing the ratio between the pixel and the actual size value. The actual size information is also called actual size conversion, a resolution, a pixel actual size value, an image actual size value, or the like of the image other than the image/actual size ratio. Since the image includes no actual size information, there are provided a method of manually inputting actual size information by the user, a method of estimating the actual size information of the image from the size of an obvious defect, and a method of acquiring actual size information using another distance measuring device simultaneously with capturing. In this embodiment, the method of manually inputting actual size information by the user will be described later.

The image management unit 213 has a function of performing at least one of storage of an image, registration, deletion, list display, and browsing of images in a folder, change of an image resolution, and change of a file name. The image storage unit 214 stores data and settings of an image. The image management unit 213 manages a plurality of images by registering them in a folder. When storing images, the user designates one folder in which the images are to be registered. The image management unit 213 makes a setting for applying the image resolution set by the user to the images registered in the folder designated by the user. The image storage unit 214 stores the settings of the images registered in the folder.

The image analysis unit 215 executes image analysis using a learning model generated by machine learning/deep learning of Artificial Intelligence (AI) to detect a defect from images that are obtained by capturing an inspection target and managed in a folder. The analysis result storage unit 217 stores an image analysis result.

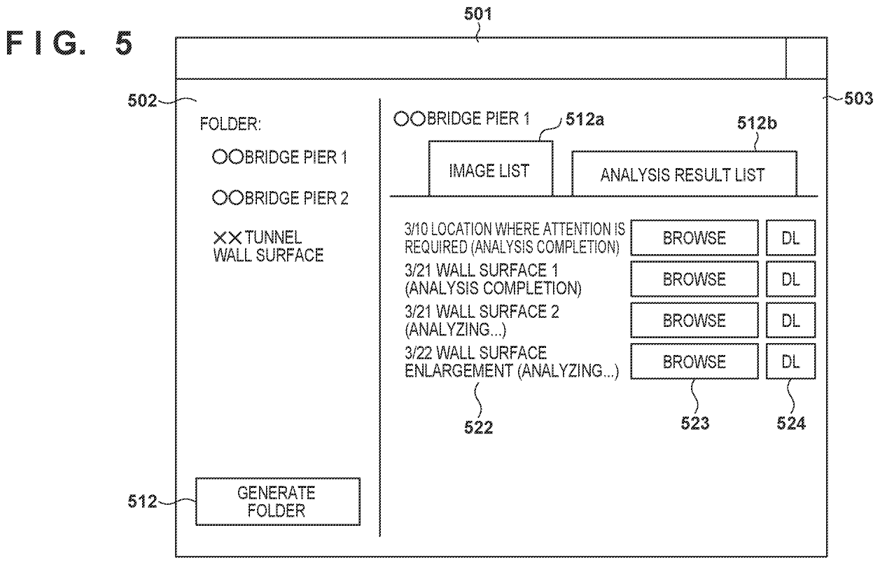

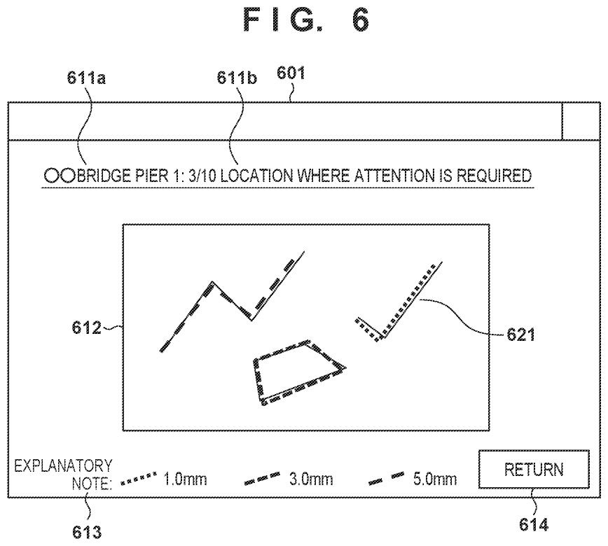

The analysis result management unit 216 has a function of performing browsing, acquisition, and the like of the image analysis result stored in the analysis result storage unit 217. The analysis result management unit 216 presents, to the user, an analysis result list screen to be described later with reference to FIG. 5 and an analysis result browsing screen to be described later with reference to FIG. 6.

### <Workflow of Detecting Defect>

An example of a workflow when detecting a defect from an image obtained by capturing an inspection target will be described below as the premise of this embodiment. In this embodiment, image analysis is performed using a learning model for an image obtained by capturing, by a camera, a wall surface of a concrete structure, thereby detecting a defect.

When capturing an inspection target on site, one image hardly includes the entire range of the inspection target at an image resolution enough to detect a defect. Thus, a close up operation and capturing a part of the range of the inspection target is repeatedly performed while gradually moving the capturing range. Then, after performing image processing such as enlargement, reduction, rotation, projection conversion, color adjustment, and noise removal for a plurality of thus captured images, the plurality of images having undergone the image processing are combined to generate one composite image.

By repeatedly performing such operation in accordance with the number of constituent elements of the drawing of the inspection target, for example, by repeatedly such operation with respect to four side surfaces in the case of a pier with a rectangular sectional surface that forms a bridge, a set of four images of “OO bridge pier 1” is prepared. The standard image resolution (for example, 0.5 mm/pixel for a bridge and 2.0 mm/pixel for a tunnel) of the drawing is determined in accordance with the inspection target, and an image is captured to satisfy the condition. However, to perform intensive inspection, a high-resolution image may be captured. After that, by generating a composite image to align with the resolution of the drawing, preparation of the images for image analysis is completed.

Note that unlike a method of manually recording a defect while viewing images, a defect detected by image analysis to be described later may include erroneous detection or detection omission. Therefore, the image processing apparatus or an external server is used to perform visual confirmation and correction. For example, in case that a defect is a crack, the crack is superimposed on the drawing or images to generate an analysis result added with the length and width of the crack.

### <Image List Screen and Folder Generation Screen>

The image list screen and the folder generation screen according to this embodiment will be described next with reference to FIGS. 3 and 4.

FIG. 3 is a view exemplifying the image list screen. An image list screen 301 shown in FIG. 3 includes a folder list area 302 and an image list area 303.

In the folder list area 302, the folder names of generated folders are arranged and displayed in a predetermined order (for example, the order of the folder name or generation date and time) and a folder generation button 312 is also displayed. When the user selects a desired folder from a folder list 311, an image list 322 registered in the selected folder is displayed in the image list area 303. In the image list area 303, image files registered in the desired folder arbitrarily selected by the user from the folder list 311 displayed in the folder list area 302 are arranged and displayed in a predetermined order (for example, the order of the file name or generation date and time). In addition, in the image list area 303, an image list tab 321a, an analysis result list tab 321b, an image registration button 323, and an analysis start button 324 are displayed. The image list tab 321a is a button used to display, in the image list area 303, the image files registered in the folder selected from the folder list area 302. The analysis result list tab 321b is a button used to display, in the image list area 303, the analysis result of the image files registered in the folder selected from the folder list area 302.

When newly generating a folder, the user operates the folder generation button 312. When registering an image file in a folder, the user operates the image registration button 323. When executing image analysis, the user operates the analysis start button 324.

When registering an image file in a folder, when a desired folder does not exist in the folder list 311, the user can operate the folder generation button 312 to newly generate a folder.

When the folder generation button 312 is operated, a folder generation screen 401 shown in FIG. 4 is displayed.

FIG. 4 is a view exemplifying the folder generation screen. The folder generation screen 401 includes a folder name input field 411, an image resolution input field 412, an OK button 421, and a cancel button 422.

The user inputs, to the folder name input field 411, a name that makes it easy to discriminate the inspection target, such as the name of the inspection target, and inputs, to the image resolution input field 412, an image resolution to be applied to an image registered in a folder. The OK button 421 is a button used to confirm the folder name input to the folder name input field 411 and the image resolution input to the image resolution input field 412 and store the settings of the folder. The cancel button 422 is a button used to cancel the folder name input to the folder name input field 411 and the image resolution input to the image resolution input field 412 and return to the image list screen 301.

When the image registration button 323 in the image list area 303 on the image list screen 301 shown in FIG. 3 is operated, a screen for prompting the user to select an image to be registered in the folder is displayed. By setting, in the folder in which images are to be registered, the image resolution to be applied to the images, the user can apply, to all the images registered in the folder, the image resolution set in the folder when registering the images. Each image file displayed in the image list 322 is added with the applied image resolution or the changed image resolution.

Furthermore, an edit button 325 is displayed for each image file displayed in the image list 322, and can be used to edit the file name and image resolution of the corresponding image file. In addition, a checkbox 326 is displayed for each image file displayed in the image list 322. If the user checks the checkbox of the desired image file and then operates the analysis start button 324, input of notes on execution is accepted, and image analysis is executed for the image file whose checkbox has been checked. The notes on execution is, for example, additional information that can arbitrarily be input by the user, such as date and time information of execution of image analysis, an inspection location, and the caution level of the inspection target.

When the analysis result list tab 321b in the image list area 303 on the image list screen 301 shown in FIG. 3 is operated, an analysis result list screen 501 shown in FIG. 5 is displayed. By giving an image resolution as one parameter to a learning model used for image analysis, image analysis according to the actual size information of a defect is executed, and it can be expected to improve detection accuracy, as compared with a case where no image resolution is given.

### <Analysis Result List Screen and Analysis Result Browsing Screen>

The analysis result list screen and the analysis result browsing screen according to this embodiment will be described next with reference to FIGS. 5 and 6.

FIG. 5 is a view exemplifying the analysis result list screen. The analysis result list screen 501 includes a folder list area 502 and an analysis result list area 503. The folder list area 502 is the same as the folder list area 302 on the image list screen 301 shown in FIG. 3. A folder generation button 512 in the folder list area 502 is the same as the folder generation button 312 on the image list screen 301 shown in FIG. 3.

In the analysis result list area 503, an analysis result list 522 as a result of executing image analysis for the image file whose checkbox has been checked in the image list 322, an image list tab 512a, and an analysis result list tab 512b are displayed. The user can display the image list screen 301 shown in FIG. 3 by operating the image list tab 521a.

In the analysis result list 522, one of analysis completion, analyzing, and analysis failure is displayed as the status of image analysis is displayed together with the notes on execution, and a browse button 523 and a download button 524 are displayed for each analysis result. With respect to a desired analysis result in the analysis result list 522, when the browse button 523 is operated, an analysis result browsing screen 601 shown in FIG. 6 is displayed, and when the download button 524 is operated, a data file of a defect detected by the image analysis is downloaded from the external server.

FIG. 6 is a view exemplifying the analysis result browsing screen. The analysis result browsing screen 601 displays a folder name 611a, notes on execution 611b, an analysis result display field 612, an explanatory note display field 613, and a return button 614. As the folder name 611a and the notes on execution 611b, the folder name and the notes on execution of a folder in which the image file having undergone the image analysis is registered are displayed. In the analysis result display field 612, an analysis result 621 such as a crack as a defect detected by the image analysis is superimposed and displayed on the detection target image. The crack includes actual size information of a length and thickness (width), and is identifiably displayed in a display form (for example, a color or line type) that is different depending on the length and thickness (width) of the crack. In the explanatory note display field 613, the correspondence between the actual size information of the length and thickness (width) of the crack and the display form is displayed. The actual size information of the length and thickness (width) of the crack can be calculated based on the image resolution and the number of pixels of the image. By collating the actual size information of the crack with the data of the drawing, it is possible to convert the coordinates of the analysis result into numerical values in accordance with the coordinate system of the drawing, thereby allowing browsing and editing in the image processing apparatus or the external server.

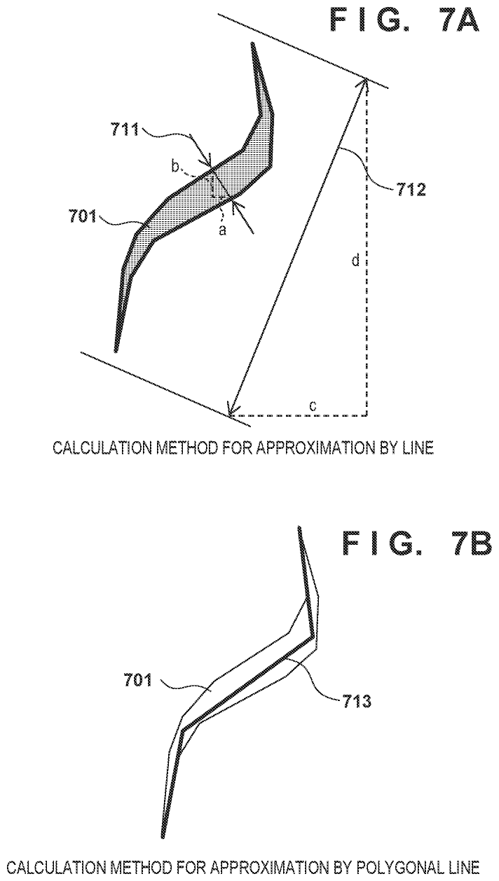

FIGS. 7A and 7B are views illustrating a method of calculating the actual size information of a crack based on the image resolution and the number of pixels of the image. FIG. 7A is a view illustrating a calculation method of approximating a crack by a line. FIG. 7B is a view illustrating a calculation method of approximating a crack by a polygonal line.

With respect to a crack 701 shown in FIG. 7A, a thickness (width) 711 of the crack is actual size information to be obtained. In an image of the inspection target, the thickness (width) 711 of the crack has an area in an oblique direction, and is thus calculated based on lengths in the horizontal and vertical directions. When k represents the image resolution of the image corresponding to the thickness (width) 711 of the crack, a represents the number of pixels in the horizontal direction, and b represents the number of pixels in the vertical direction, the actual size information can be calculated by approximation expression 1 by a line.

$$k \times \sqrt{( a \times a + b \times b )} \qquad ( Expression 1 )$$

Similarly, a length 712 of the crack can be calculated by replacing the number a of pixels in the horizontal direction and the number b of pixels in the vertical direction corresponding to the thickness (width) 711 of the crack by a number c of pixels in the horizontal direction and a number d of the pixels in the vertical direction corresponding to the length 712 of the crack in expression 1. Note that in the case of a crack having a curved shape that is not suitable for approximation by a line, it is possible to approximate the crack 701 by a plurality of lines like a polygonal line 713, and calculate the length from the sum of the lengths of the respective lines of the polygonal line 713, as shown in FIG. 7B.

The user can operate the return button 614 of the analysis result browsing screen 601 to display the analysis result list screen 501 shown in FIG. 5.

### <Processing of Executing Image Analysis>

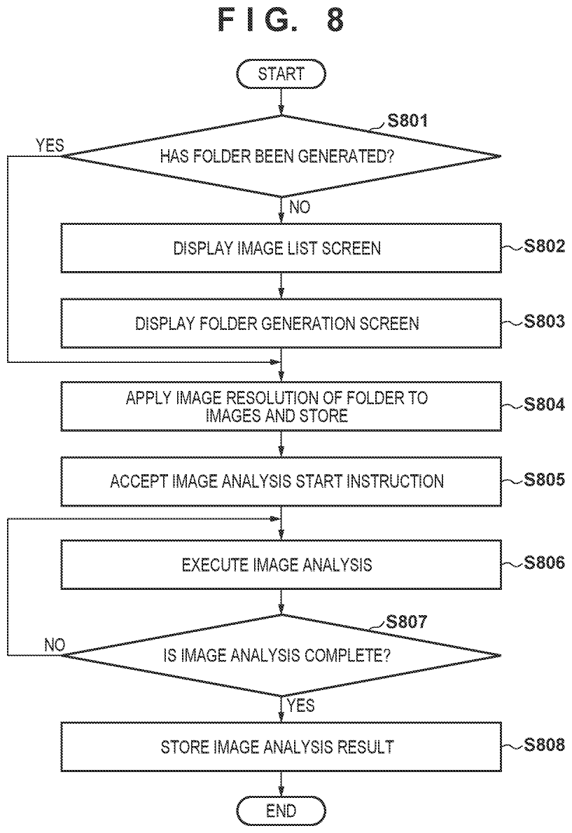

FIG. 8 is a flowchart showing processing of executing image analysis by the image processing apparatus according to this embodiment.

The processing shown in FIG. 8 is implemented when the control unit 101 of the image processing apparatus 100 shown in FIG. 1 controls the respective components by deploying the programs stored in the non-volatile memory 102 to the working memory 103 and executing the programs, and executes the functions shown in FIG. 2.

In step S801, the control unit 101 determines whether a folder in which detection target images are registered has been generated. Upon determining that the folder has been generated, the control unit 101 advances the process to step S804; otherwise, the control unit 101 advances the process to step S802.

In step S802, the control unit 101 causes the folder management unit 211 to display the image list screen 301 shown in FIG. 3 on the output device 106, and accepts the operation of the folder generation button 312.

In step S803, the control unit 101 causes the folder management unit 211 to display the folder generation screen 401 shown in FIG. 4 on the output device 106, and accepts the input to the folder name input field 411 and the input to the image resolution input field 412. Furthermore, upon accepting the operation of the OK button 421, the control unit 101 causes the folder management unit 211 to newly generate a folder and store the folder name of the folder to be newly generated and the setting of an image resolution in the folder setting storage unit 212. By setting, in the folder in which the images are to be registered, the image resolution to be applied to the images, the image resolution set in the folder when registering the images can be applied to all the images registered in the folder.

In step S804, the control unit 101 causes the folder management unit 211 to display the image list screen 301 shown in FIG. 3 on the output device 106. Upon accepting the operation of the image registration button 323, the control unit 101 sets the images to be registered by the image management unit 213 so as to apply, to the images to be registered, the image resolution in the setting of the folder stored in the folder setting storage unit 212 in step S803, and causes the image storage unit 214 to store the settings of the images. In this way, by setting, in the folder in which the images are to be registered, the image resolution to be applied to the images, it is possible to apply, to all the images registered in the folder, the image resolution set in the folder when registering the images.

In step S805, the control unit 101 causes the folder management unit 211 to display the image list screen 301 shown in FIG. 3 on the output device 106, and accepts an operation of checking the checkbox of a desired image file and the operation of the analysis start button 324.

In step S806, the control unit 101 causes the image analysis unit 215 to execute image analysis for the image file whose checkbox has been checked.

In step S807, the control unit 101 determines whether the image analysis by the image analysis unit 215 is complete. Upon determining that the image analysis is complete, the control unit 101 advances the process to step S808;

otherwise, the control unit 101 returns the process to step S806.

In step S808, the control unit 101 causes the analysis result storage unit 217 to store an image analysis result. Furthermore, upon accepting the operation of the analysis result list tab 321b on the image list screen 301 shown in FIG. 3, the control unit 101 causes the analysis result management unit 216 to display the analysis result list screen 501 shown in FIG. 5 on the output device 106.

As described above, according to the first embodiment, by setting, in the folder in which the detection target images are to be registered, the image resolution to be applied to the images, it is possible to apply, to all the images registered in the folder, the image resolution set in the folder when registering the images. Therefore, since it is unnecessary to manually set an image resolution for each detection target image, it is possible to reduce the burden of an operation of setting the image resolution for each detection target image. In addition, since image analysis is executed in accordance with the set image resolution, it can be expected to improve accuracy of detection of a defect, as compared with image analysis in which no image resolution is given.

### Second Embodiment

The first embodiment has described an example in which a folder name and an image resolution are input to the folder generation screen 401 shown in FIG. 4 when generating a folder. To the contrary, the second embodiment will describe an example in which when an image resolution input to a folder generation screen 401 deviates from a standard value or a recommended value, a warning is displayed to the user or an appropriate value is automatically set.

### <Image Resolution in Generating Folder>

On the folder generation screen 401 shown in FIG. 4, the input of a folder name to a folder name input field 411 before an image resolution can be used to perform processing according to the recommended value of the image resolution in a case where the folder name matches a word set in accordance with the name (bridge, tunnel, or the like) of an inspection target registered in advance.

For the image resolution, a standard value or a recommended value is preset by an experiment or the like in accordance with an inspection target. For example, the standard value or recommended value of the image resolution for a “pier” of a bridge is “0.5”. In this embodiment, if the user erroneously inputs “5.0” to an image resolution input field 412, this value deviates from the standard value or recommended value, and thus a warning is displayed. More specifically, in a case where the image resolution is over 50% more or less than the standard value or recommended value, in this example, in a case where the image resolution deviates from a predetermined range of 0.25 to 1.0, a warning is displayed to the user on the folder generation screen 401, a popup screen displayed when the OK button 421 is operated, or the like. This can prompt the user to perform correction.

Alternatively, in a case where the image resolution deviates from the predetermined range, “0.5” as the standard value or the recommended value may automatically be input to the image resolution input field 412. The automatically input value may be changeable by the user.

### Third Embodiment

The first embodiment has described the example in which image analysis is executed after notes on execution is set. The third embodiment will describe an example in which an image analysis method is selected by the user or is automatically set.

### <Image Analysis Method Selection Screen>

FIG. 9 is a view exemplifying an image analysis method selection screen.

When an image registration button 323 is operated on an image list screen 301 shown in FIG. 3, an image analysis method selection screen 901 shown in FIG. 9 is displayed.

The image analysis method selection screen 901 includes an notes on execution input field 911, a learning model selection field 912, a parameter input field 913, an OK button 921, and a cancel button 922.

The same notes on execution as in the first embodiment is input to the notes on execution input field 911. In the learning model selection field 912, a plurality of learning models are selectable. The user can select a learning model suitable to an inspection target from the plurality of learning models registered in the learning model selection field 912. A parameter such as an image resolution given to the learning model can be input to the parameter input field 913. A plurality of parameters (for example, three parameters) can be input for each of the learning models selectable in the learning model selection field 912. The OK button 921 is a button used to confirm the notes on execution input to the notes on execution input field 911, the learning model selected from the learning model selection field 912, and the one or more parameters input to the parameter input field 913, and store the settings of the image analysis method. The cancel button 922 is a button used to cancel the notes on execution input to the notes on execution input field 911, the learning model selected from the learning model selection field 912, and the one or more parameters input to the parameter input field 913, and redo input operations.

Since each learning model is obtained by performing learning in advance using a specific detection target image, it can be expected to improve accuracy when the user selects the learning model suitable to the inspection target. In addition, it is also possible to improve accuracy by changing parameters and comparing analysis results with respect to the same learning model or preparing and introducing a learning model in accordance with the environment of the user. This embodiment has described the example in which the user manually selects the image analysis method on the image analysis method selection screen 901. However, when the image processing apparatus automatically selects the image analysis method, the burden of the operation can be reduced. For example, when the input of the notes on execution to the image analysis method selection screen 901 before the selection of the learning model is used, and a word such as “pier” or “bridge” is included, a “pier learning model” is automatically selected as a recommended option, and the user can change the learning model later.

### Fourth Embodiment

Each of the first to third embodiments has described an example in which by setting an image resolution in a folder, the image resolution of the folder is applied to images when registering the images. To the contrary, the fourth embodiment will describe an example in which a folder can be generated to have a hierarchical structure and the resolution of an upper folder or an arbitrary resolution is applied to a lower folder or image in a layer lower than that of the upper folder.

### <Concept of Subfolder>

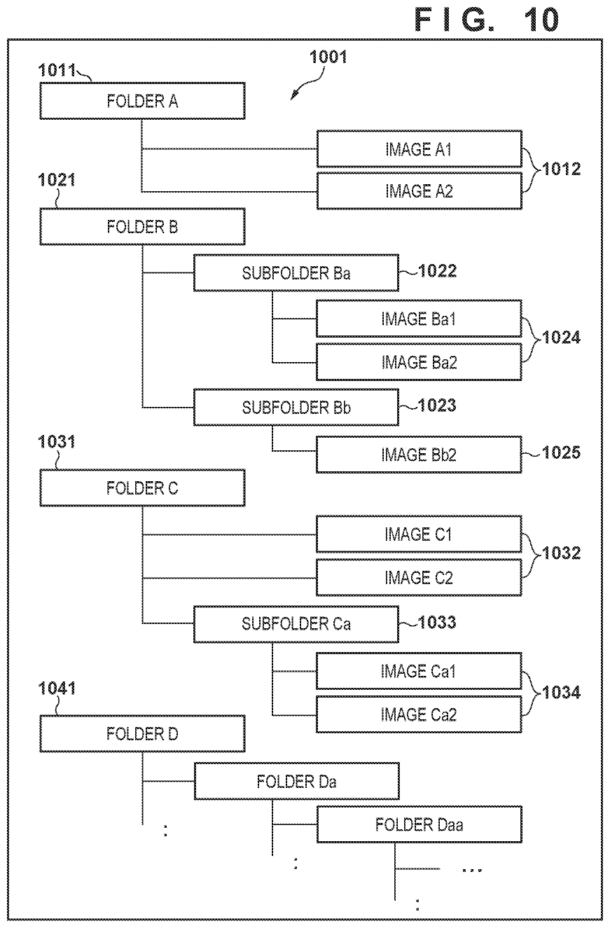

FIG. 10 is a schematic view illustrating a folder structure 1001 according to the fourth embodiment.

The relationship between a folder and an image described in each of the first to third embodiments is based on the assumption that images are registered immediately below a folder like two images 1012 registered in a folder 1011. In the fourth embodiment, a function capable of hierarchically registering at least one folder is added.

In a folder 1021, subfolders 1022 and 1023 are registered under the folder 1021, two images 1024 are registered under the subfolder 1022, and an image 1025 is registered under the subfolder 1023. In a folder 1031, two images 1032 and a subfolder 1033 are registered under the folder 1031, and two images 1034 are registered under the subfolder 1033. In this way, at least one subfolder or image can be registered in a folder. When a folder and a subfolder are collectively referred to as folders and a folder and an image are collectively referred to as elements, since at least one element can be registered under an upper folder, the hierarchical structure of the folder and the image can be implemented. For example, it is possible to implement, under an uppermost folder 1041, a multi-hierarchical structure in which an arbitrary number of folders and an arbitrary number of images are registered.

With this function, it is possible to more efficiently manage folders and images by generating subfolders “pier 1” and “pier 2” under a folder “OO bridge”, instead of generating folders “OO bridge pier 1” and “OO bridge pier 2”.

FIG. 10 shows an example of generating a plurality of uppermost folders. However, the number of uppermost folders may be limited to one and all elements may be registered under the uppermost folder.

### <Description of Folder Structure of Two Layers>

For the sake of descriptive convenience, a folder and a subfolder of two layers will be exemplified below. However, the present invention is not limited to this, and a multi-hierarchical structure in which an arbitrary number of folders and an arbitrary number of images are registered may be adopted.

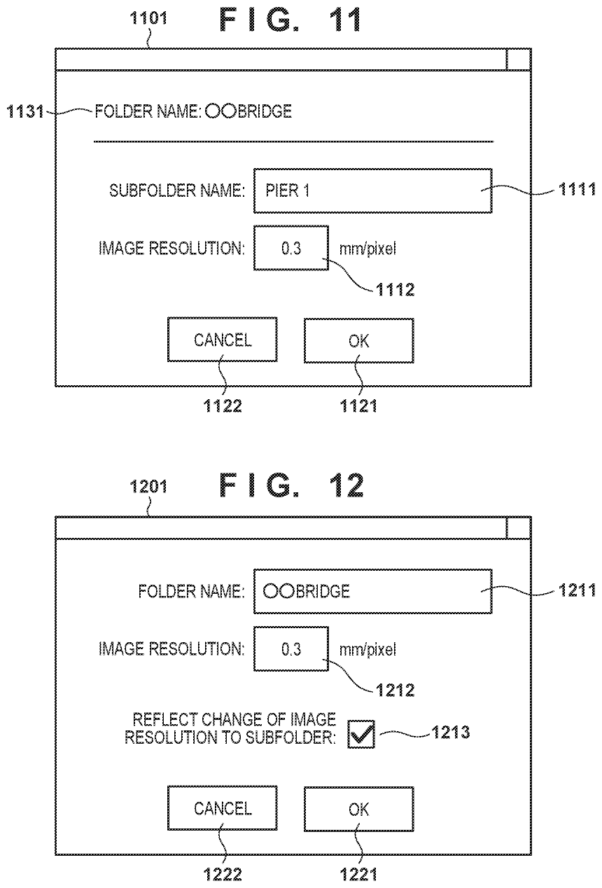

In the fourth embodiment, a folder management unit 211 has a function of performing generation, setting, deletion, list display, and the like of subfolders in addition to the function described in the first embodiment. Furthermore, a subfolder generation screen to be described later with reference to FIG. 11 and a folder editing screen to be described later with reference to FIG. 12 are presented to the user. When generating a subfolder, the user designates an upper folder to display the subfolder generation screen, and inputs a subfolder name and an image resolution as subfolder setting information to the subfolder generation screen. The subfolder setting information may include information such as notes on execution input when generating the subfolder, and the generation date and time and the access date and time for subfolder management in addition to the subfolder name and the image resolution.

The subfolder generation screen according to the fourth embodiment will be described next with reference to FIG. 11. A subfolder generation screen 1101 includes a folder name display field 1131, a subfolder name input field 1111, an image resolution input field 1112, an OK button 1121, and a cancel button 1122.

The user inputs, to the subfolder name input field 1111, a name that makes it easy to discriminate an inspection target, such as the name of the inspection target, and inputs, to the image resolution input field 1112, an image resolution to be applied to an image registered in the subfolder. An image resolution set in the upper folder designated by the user and displayed in the folder name display field 1131 is automatically input as an initial value to the image resolution input field 1112, and the user can change the initial value. The OK button 1121 is a button used to confirm and store the subfolder name input to the subfolder name input field 1111 and the image resolution input to the image resolution input field 1112. The cancel button 1122 is a button used to cancel the subfolder name input to the subfolder name input field 1111 and the image resolution input to the image resolution input field 1112 and return to an image list screen 301.

The folder editing screen for editing a generated folder will be described next with reference to FIG. 12. A folder editing screen 1201 includes a folder name input field 1211, an image resolution input field 1212, a checkbox 1213 for reflecting an image resolution on a lower element, an OK button 1221, and a cancel button 1222.

The user can confirm the folder name input field 1211 and the image resolution input field 1212 on which the folder setting information input when generating a folder is reflected, and change them, as needed. Furthermore, the user can set, by the checkbox 1213 for reflecting the changed image resolution on a subfolder, whether to reflect the image resolution input to the image resolution input field 1212 on a lower folder. If the checkbox 1213 is checked, the image resolution input to the image resolution input field 1212 is automatically reflected on all the folders and images in the editing folder; otherwise, the image resolution input to the image resolution input field 1212 is reflected on not the folders and images in the editing folder but a folder and image to be newly registered in the editing folder. The OK button 1221 is a button used to confirm the setting of the checkbox 1213, and reflect and store the image resolution input to the image resolution input field 1212 on the subfolder. The cancel button 1222 is a button used to cancel the setting of the checkbox 1213 and return to the image list screen 301 shown in FIG. 3 without reflecting the image resolution input to the image resolution input field 1212 on the subfolder.

### [Modification]

Each of the above-described embodiments has described an example of accepting a single value as an image resolution but different values in the vertical and horizontal directions may be accepted.

Each of the above-described embodiments has described an example of a composite image as an image registered in a folder. However, individual images before composition may be registered intact.

Furthermore, each of the above-described embodiments has described an example of applying an image resolution set in a folder to images when registering the images in the folder. To the contrary, an image resolution input screen may be displayed when registering images, an initial value of an image resolution may already be input to an editable input field, and then the user may be required to edit and accept the value.

As described above, the present embodiment can reduce the burden of an operation of setting information such as a resolution for a detection target image.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image processing apparatus comprising:
a folder management unit that performs generation and setting of a folder that manages images for detecting a defect of an inspection target; and
an image management unit that sets the images managed in the folder,
wherein the folder management unit sets a resolution of the images managed in the folder, and
the image management unit applies the resolution set by the folder management unit to the images managed in the folder.

2. The image processing apparatus according to claim 1, further comprising an image analysis unit that executes image analysis for the images.

3. The image processing apparatus according to claim 1, wherein the folder management unit performs at least one of generation, setting, deletion, and list display of the folder.

4. The image processing apparatus according to claim 1, wherein the image management unit performs at least one of storage of an image, registration, deletion, list display, and browsing of the images in the folder, change of the resolution of the images, and change of a file name.

5. The image processing apparatus according to claim 2, further comprising:
a folder setting storage unit that stores settings of the folder;
an image storage unit that stores settings of the images; and
an analysis result storage unit that stores a result of the image analysis.

6. The image processing apparatus according to claim 2, wherein
the folder management unit sets the resolution of the images managed in the folder in accordance with a user operation;
the image management unit applies the resolution to the images managed in the folder, and
the image analysis unit executes the image analysis using the resolution applied to the images and a learning model that executes image analysis by inputting the images.

7. The image processing apparatus according to claim 2, wherein the image analysis unit executes image analysis according to actual size information of a defect of the inspection target by giving, as one parameter, the resolution of the images to a learning model used for the image analysis.

8. The image processing apparatus according to claim 2, wherein
the folder management unit displays a list of the images managed in the folder, and
the image analysis unit displays an image analysis result concerning the images.

9. The image processing apparatus according to claim 1, wherein the folder management unit displays a screen used to input a folder name and a resolution as settings of the folder.

10. The image processing apparatus according to claim 2, wherein
the folder management unit displays a screen used to select an image analysis method by the image analysis unit as settings of the folder, and
the image analysis method includes a learning model that executes the image analysis by inputting the images and a resolution to be given to the learning model.

11. The image processing apparatus according to claim 10, wherein the folder management unit selects the image analysis method based on a name of the inspection target, and displays the image analysis method on the screen.

12. The image processing apparatus according to claim 9, wherein in a case where the resolution input to the screen deviates from a standard value or a recommended value, the folder management unit displays a warning or inputs the standard value or the recommended value to the screen.

13. The image processing apparatus according to claim 2, wherein based on data of a drawing of the inspection target, the image analysis unit converts coordinates of an analysis result into numerical values in accordance with a coordinate system of the drawing.

14. The image processing apparatus according to claim 1, wherein the folder management unit generates and sets, in a multi-hierarchical structure, the folder that manages the images for detecting the defect.

15. The image processing apparatus according to claim 14, wherein the folder management unit automatically inputs, to a screen for generating a lower folder in a layer lower than a layer of an upper folder, a resolution of an image set in the upper folder.

16. The image processing apparatus according to claim 14, wherein in a case where a resolution of an image set in an upper folder is edited, the folder management unit automatically reflects the edited resolution on all lower folders in accordance with an instruction to apply the edited resolution to the lower folders in layers lower than a layer of the upper folder.

17. An image processing method comprising:
generating and setting a folder that manages images for detecting a defect of an inspection target; and
setting the images managed in the folder,
wherein in the folder setting, a resolution of the images managed in the folder is set, and
in the image setting, the resolution set in the folder setting is applied to the images managed in the folder.

18. A non-transitory computer-readable storage medium storing a program for causing a computer to function as an image processing apparatus comprising:
a folder management unit that performs generation and setting of a folder that manages images for detecting a defect of an inspection target; and
an image management unit that sets the images managed in the folder,
wherein the folder management unit sets a resolution of the images managed in the folder, and
the image management unit applies the resolution set by the folder management unit to the images managed in the folder.
